(19) United States
(12) Patent Application Publication
(10) Pub. No.: US 2019/0376874 A1
(43) Pub. Date: Dec. 12, 2019

(54) A METHOD OF ESTIMATING THE NUMBER OF MODES FOR THE SPARSE COMPONENT ANALYSIS BASED MODAL IDENTIFICATION

(71) Applicant: Dalian University of Technology, Dalian, Liaoning (CN)

(72) Inventors: Tinghua YI, Dalian, Liaoning (CN); Xiaojun YAO, Dalian, Liaoning (CN); Hongnan LI, Dalian, Liaoning (CN)

(21) Appl. No.: 16/342,946

(22) PCT Filed: Mar. 20, 2018
(86) PCT No.: PCT/CN2018/079565

§ 371 Date: Apr. 17, 2019

(30) Foreign Application Priority Data
Dec. 1, 2017 (CN) 201711246435.4

(51) Int. Cl. G01M 5/00

(52) U.S. Cl. CPC G01M 5/0066

(57) ABSTRACT

Data analysis for structural health monitoring, relating to a method of estimating the number of modes for sparse component analysis based structural modal identification. First, structural responses are transformed into time-frequency domain using short-time Fourier transform method. Single-source-point detection method is applied to the time-frequency coefficients to pick out the single-source-points where only one mode makes contribution. The single-source-point vectors are normalized to the upper half unit circle. Three statistics are given to analyze the statistical property. The suggested number of subintervals is given. Through counting, the approximate probabilities in subintervals are calculated and then smoothed through the weighted average procedure. The local maximum values of the averaged probability curve are detected and the number of active modes is equal to the number of local maximum values.

### TECHNICAL FIELD

The present invention belongs to the technical field of data analysis for structural health monitoring, and relates to a method of estimating the number of modes for the modal identification of civil engineering structures.

### BACKGROUND

Structural modal identification aims to identify the modal frequencies, damping ratios and mode shapes of civil structures. Estimating the modal parameters is of importance for model updating, modal parameter-based damage identification and serviceability assessment. In recent years, blind source separation (BSS) based modal identification method has been studied extensively. The object of BSS is to separate original signals and mixing system from the mixed signals of a linear system. When the modal identification problem is cast into the BSS framework, the modal matrix and the modal responses correspond to the mixing system and the original sources, respectively. Therefore, it is feasible to use BSS theory to extract the modal matrix and modal responses from the vibration measurements.

In practical applications, the number of available sensors may be less than the number of active modes, which is called the underdetermined BSS problem. Sparse component analysis (SCA) method is a powerful tool to solve underdetermined BSS problem. The only assumption of SCA is that the modal responses are sparse in some transformed domain, such as time-frequency domain. Based on the linear clustering property of time-frequency domain measurements, mode shapes can be estimated through clustering techniques. Modal responses are recovered using sparse reconstruction techniques with the known mode shapes. Though the SCA method is capable of handling the underdetermined BSS problem, the number of modes which is equal to the number of clusters should be known in the procedure of clustering, which limits the application of SCA.

Though the density-based clustering technique can identify the number of clusters automatically, the optimal parameters used in the clustering are hard to determine, which will result in unsatisfactory consequence. In addition, Akaike Information Criterion and Minimum Description Length criterion are developed for estimating the number of original sources. However, these methods are not suitable for under-determined BSS, because it is assumed that the number of sources is less than the number of sensors. Fortunately, the statistical property of the measurements in sparse domain is suitable for estimating the number of sources, which can be cast into the estimation of active modes number. Because the fact that the number of modes is usually unknown, it is very important to estimate the number of modes precisely for accurate estimation of mode shapes and modal responses.

### SUMMARY

The object of the present invention is to provide a method to estimate the number of active modes in the procedure of structural modal identification based on SCA, with which the accuracy and the convenience for the application of SCA based modal identification are improved.

The technical solution of the present invention is as follows: The procedures of estimating the number of modes for the SCA based structural modal identification are as follows:

1. Detecting the Time-Frequency Points where Only One Mode Makes Contribution.

Step 1: Transforming the Sampled Accelerations into Time-Frequency Domain

The accelerations of the structure are sampled and denoted as Acc(t)=[acc₁(t), acc₂(t), . . . , accₙ(t)]^{T}, where n is the number of sensors. Then, the responses are transformed into time-frequency domain through short-time Fourier transform, which are denoted as Acc(t, f)=[acc₁(t, f), acc₂(t, f), . . . , accₙ(t, f)]^{T}. f is the frequency index.

Step 2: Detecting the Single-Source-Points

When one mode is dominant in a point, this type of point is called the single-source-point. The directions formed by the real and the imaginary parts of the time-frequency coefficients will not exceed a very small angle, which is called the threshold and noted as Δα. Based on this property, the single-source-point detection can be accomplished through:

$$\vert \frac{Re {\{ Acc ( t , f ) \}}^{T} Im \{ Acc ( t , f ) \}}{‖ Re \{ Acc ( t , f ) \} ‖ ‖ Im \{ Acc ( t , f ) \} ‖} \vert > cos ( Δ α )$$

where Re{⋅} and Im{⋅} are the real and imaginary parts of a vector, respectively; The detected single-source-points are marked as (tⱼ, fⱼ). Therefore, the time-frequency coefficients of the single-source-points are denoted as Acc(tⱼ, fⱼ)=[Acc₁(tⱼ, fⱼ), Acc₂ (tⱼ, fⱼ), . . . , Accₙ (tⱼ, fⱼ)]^{T}.

2. Identifying the Number of Active Modes

Step 3: Choosing Two Locations

Two sensor locations k and l are chosen arbitrarily and the corresponding single-source-points of these two locations are Accₖ (tⱼ,fⱼ) and Acc₁(tⱼ, fⱼ).

Step 4: Normalizing the Single-Source-Point Vectors

First, the single-source-points of the locations k and l are arranged in column vectors, respectively. Then, the single-source-point vectors are denoted as Acc1=[Accₖ, Accₗ]^{T}. Acc1 should be normalized to the upper half unit circle using:

$$A cc 1 ( i ) = \{ \begin{matrix}\frac{Acc 1}{‖ Acc 1 ( i ) ‖} , A cc {1}_{k} ( i ) \geq 0 \\ - \frac{A cc 1}{‖ A cc 1 ( i ) ‖} , Acc {1}_{k} ( i ) < 0\end{matrix}$$

where Âcc1(i) is the normalized data of the i-th row vector in Acc1.

Step 5: Constructing the Statistics

If the two elements in Acc1 are treated as the coordinates of a point in the Cartesian coordinates, the coordinates of the arbitrary points are Âcc1(i)=[Âccₖ (i), Âccₗ(i)]^{T}, i=(1, 2, . . . , J), where J is the total number of points in Âcc1. Three distance based statistics are constructed by the Euclidean distance and the Chebyshev distance between the points in Âcc1 and the left end point [−1, 0]^{T}, and the cosine distance between the points in Âcc1 and the center point [0,0]^{T}. The Euclidean distance is formulated as follows:

dist_{E}(i)={square root over ((Accₖ(i)+1)²+Accₗ(i)²)}

The Chebyshev distance is formulated as follows:

dist_{C}(i)=max(|Accₖ(i)+1|,|Accₗ(i)|)

The cosine distance is formulated as follows:

$${dist}_{θ} ( i ) = arccos ( \frac{{Acc}_{k} ( i )}{\sqrt{{{Acc}_{k} ( i )}^{2} + A {{cc}_{i} ( i )}^{2}}} )$$

The final statistic dist is determined from dist_{E}, dist_{C} and dist_{θ}.

Step 6: Determining the Suggested Values of the Number of Statistical Subintervals

The statistic dist is sorted in descending order and then the sorted data is differentiated as Δ (dist). The difference sequence is counted. When the accumulated sample size reaches 95% of the total sample size, a threshold is set and the samples beyond the threshold are removed. The remainder difference sequence is averaged to obtain the mean value Δₘₑₐₙ. The maximum of the remainder difference sequence is Δₘₐₓ. The relation between the number and the length of the statistical intervals is:

$$P = \frac{max ( dist ) - min ( dist )}{δ}$$

where max(⋅) and min(⋅) are the maximum and minimum of a vector, respectively. When δ is equal to the mean value Δₘₑₐₙ, the number of statistical subintervals is at a maximum and is denoted as Pₘₐₓ. When δ is equal to the maximum value Δₘₐₓ, the number of statistical subintervals is at a minimum and is denoted as Pₘᵢₙ. Therefore, the range for the suggested number of statistical subintervals is given as P∈[Pₘᵢₙ,Pₘₐₓ].

Step 7: Calculating the Approximate Probability Curve

The statistical interval [max (dist)−min (dist)] is divided into P subintervals with equal length. The number of samples in each subinterval is counted and denoted as pᵢ, i=(1, 2, . . . , P). The approximate probability in each subinterval is calculated using Pr(i)=pᵢ/P. The approximate probability curve is obtained through the weighted average procedure:

\hat{P}r(i)= 1/16(P(i−2)+4P(i−1)+6P(i)+4P(i+1)+P(i+2))

where \hat{P}r is the approximate probability curve.

Step 8: Picking the Local Maximum Values

The local maximum values of Pr are picked out and the number of active modes is equal to the number of local maximum values.

The advantage of this invention is that the number of active modes can be estimated adaptively in the procedure of SCA based modal identification, then the accuracy and convenience for the use of SCA are improved.

### DETAILED DESCRIPTION

The present invention is further described below in combination with the technical solution.

The numerical example of a 6 degree-of-freedom in-plane lumped-mass model is employed. The mass for the first floor is 3 kg, and the masses for the other floors are 1 kg. The stiffness for the first floor is 2 kN/m, and the stiffnesses for the rest floors are 1 kN/m. The Rayleigh damping is adopted as C=αM+βK, where the factors are α=0.05 and β=0.004. The model is excited in the sixth floor by an impulse, and the free decayed response is sampled with a sampling rate of 100 Hz. The procedures are described as follows:

(1) The accelerations of the structure are sampled and denoted as Acc(t)=[acc₁(t), acc₂(t), . . . , acc₆(t)]^{T}. Then, the responses Acc(t) are transformed into time-frequency domain through short-time Fourier transform, which are noted as Acc(t, f)=[acc₁(t, f), acc₂(t, f), . . . , acc₆(t, f)]^{T}. f is the frequency index;

(2) The single-source-points are detected using:

$$\vert \frac{Re {\{ Acc ( t , f ) \}}^{T} Im \{ Acc ( t , f ) \}}{‖ Re \{ Acc ( t , f ) \} ‖ ‖ Im \{ Acc ( t , f ) \} ‖} \vert > cos ( Δ α )$$

where Re{⋅} and Im{⋅} are the real and imaginary parts of a vector, respectively; Δα is 2°. The detected single-source-points are marked as (tⱼ, fⱼ). Therefore, the time-frequency coefficients of the single-source-points are denoted as Acc(tⱼ, fⱼ)=[Acc₁(tⱼ, fⱼ), Acc₂(tⱼ, fⱼ), . . . , Acc₆ (tⱼ,fⱼ)]^{T};

(3) Two sensor locations 5 and 6 are chosen and the corresponding single-source-points of these two locations are Acc₅(tⱼ, fⱼ) and Acc₆(tⱼ, fⱼ).

(4) First, the single-source-points of the 5^{th} and 6^{th} locations are arranged in column vectors, respectively. Then, the single-source-point vectors are denoted as Acc1=[Acc₅, Acc₆]^{T}. Acc1 should be normalized to the upper half unit circle using:

$$A cc 1 ( i ) = \{ \begin{matrix}\frac{Acc 1}{‖ Acc 1 ( i ) ‖} , A cc {1}_{k} ( i ) \geq 0 \\ - \frac{A cc 1}{‖ A cc 1 ( i ) ‖} , Acc {1}_{k} ( i ) < 0\end{matrix}$$

where Âcc1(i) is the normalized data of the i-th row vector in Acc1.

(5) If the two elements in Âcc1 are treated as the coordinates of a point in the Cartesian Coordinates, the coordinates of the arbitrary points are Âcc1(i)=[Âcc₅(i), Âcc₆ (i)]^{T}, i=(1, 2, . . . , J), where J is the total number of points in Âcc1. Three distance based statistics are given formed by the Euclidean distance and the Chebyshev distance between the points in Âcc1 and the left end point [−1,0]^{T}, and the cosine distance between the points in Âcc1 and the center point [0,0]^{T}.

The distance dist_{E} is selected as the statistic dist.

(6) The statistic dist is sorted in descending order and then the sorted data is differentiated as Δ(dist). The difference sequence is counted. When the accumulated sample size reaches 95% of the total sample size, a threshold is set and the samples beyond the threshold are removed. The remainder difference sequence is averaged to obtain the mean value Δₘₑₐₙ. The maximum of the remainder difference sequence is Δₘₐₓ. The relation between the number and the length of the statistical intervals is:

$$P = \frac{max ( dist ) - min ( dist )}{δ}$$

where max(⋅) and min(⋅) are the maximum and minimum of a vector, respectively. When δ is equal to the mean value Δₘₑₐₙ, the number of statistical subintervals is at the maximum and is denoted as Pₘₐₓ. When δ is equal to the maximum value Δₘₐₓ, the number of statistical subintervals is at the minimum and is denoted as Pₘᵢₙ. Therefore, the range for the suggested number of statistical subintervals is given as P∈[Pₘᵢₙ,Pₘₐₓ].

(7) The number of statistical subintervals is chosen as P=(Pₘᵢₙ+Pₘₐₓ)/2. The statistical interval [max (dist)−min(dist)] is divided into P subintervals with equal length. The number of samples in each subinterval is counted and denoted as pᵢ, i=(1, 2, . . . , P). The approximate probability in each subinterval is calculated using Pr(i)=pᵢ/P. The approximate probability curve is obtained through the weighted average procedure:

\hat{P}r(i)= 1/16(P(i−2)+4P(i−1)+6P(i)+4P(i+1)+P(i+2))

where \hat{P}r is the approximate probability curve.

(8) Six local maximum values of \hat{P}r are picked out and the number of active modes is six.

We claim:

1. A method of estimating the number of modes for the sparse component analysis based modal identification, wherein the steps are as follows:
step 1: transforming sampled accelerations into time-frequency domain
(1) accelerations of the structure are sampled and denoted as Acc(t)=[acc₁(t), acc₂(t), . . . , accₙ(t)]^{T}, where n is number of sensors; then responses Acc(t) are transformed into time-frequency domain through short-time Fourier transform, which is noted as Acc(t, f); f is the frequency index;
(2) detecting single-source-points; a single-source-point detection method is applied to select time-frequency points where only one mode is dominant; a principle of single-source-point detection is that directions formed by the real and the imaginary parts of time-frequency coefficients will not exceed a very small angle, which is called a threshold and noted as Δα; based on this property, the single-source-point detection can be accomplished through:
$$\vert \frac{Re {\{ Acc ( t , f ) \}}^{T} Im \{ Acc ( t , f ) \}}{‖ Re \{ Acc ( t , f ) \} ‖ ‖ Im \{ Acc ( t , f ) \} ‖} \vert > cos ( Δ α )$$
where Re{⋅} and Im{⋅} are the real and imaginary parts of a vector, respectively; detected single-source-points are marked as (tⱼ, fⱼ); therefore, the time-frequency coefficients of the single-source-points are denoted as ACC(tⱼ, fⱼ)=[Acc₁(tⱼ, fⱼ), Acc₂(tⱼ, fⱼ), . . . , Accₙ(tⱼ, fⱼ)]^{T};
step 2: identifying number of active modes
(3) two sensor locations k and l are chosen arbitrarily and corresponding single-source-points of these two locations are Accₖ(tⱼ,fⱼ) and Accₗ(tⱼ, fⱼ);
(4) first, single-source-points of the locations k and l are arranged in column vectors, respectively; then, the single-source-point vectors are denoted as Acc1=[Accₖ, Accₗ]^{T}; Acc1 should be normalized to the upper half unit circle using:
$$A cc 1 ( i ) = \{ \begin{matrix}\frac{Acc 1}{‖ Acc 1 ( i ) ‖} , A cc {1}_{k} ( i ) \geq 0 \\ - \frac{A cc 1}{‖ A cc 1 ( i ) ‖} , Acc {1}_{k} ( i ) < 0\end{matrix}$$
where Âcc1(i) is normalized data of the i-th row vector in Acc1;
(5) if the two elements in Âcc1 are treated as coordinates of a point in the Cartesian coordinates, coordinates of the arbitrary points are Âcc1(i)=[Âccₖ(i), Âccₗ(i)]^{T}, i=(1, 2, . . . , J), where J is the total number of points in Âcc1; three distance based statistics are constructed by Euclidean distance and Chebyshev distance between points in Âcc1 and the left end point [−1, 0]^{T}, and the cosine distance between the points in Âcc1 and the center point [0,0]^{T}; the Euclidean distance is formulated as follows:
dist_{E}(i)={square root over ((Accₖ(i)+1)²+Accₗ(i)²)}
the Chebyshev distance is formulated as follows:
dist_{C}(i)=max(|Accₖ(i)+1|, |Accₗ(i)|)
the cosine distance is formulated as follows:
$${dist}_{θ} ( i ) = arccos ( \frac{{Acc}_{k} ( i )}{\sqrt{{{Acc}_{k} ( i )}^{2} + A {{cc}_{i} ( i )}^{2}}} )$$
the final statistic dist is determined from dist_{E}, dist_{C} and dist_{θ};
(6) the statistic dist is sorted in descending order and then the sorted data is differentiated as Δ(dist); the difference sequence is counted; when the accumulated sample size reaches 95% of the total sample size, a threshold is set and the samples beyond the threshold are removed; the remainder difference sequence is averaged to obtain the mean value Δₘₑₐₙ; the maximum of the remainder difference sequence is Δₘₐₓ; the relation between the number and the length of the statistical intervals is:
$$P = \frac{max ( dist ) - min ( dist )}{δ}$$
where max(⋅) and min(⋅) are the maximum and minimum of a vector, respectively; when δ is equal to the mean value Δₘₑₐₙ, the number of statistical subintervals is at a maximum and is denoted as Pₘₐₓ; when δ is equal to the maximum value Δₘₐₓ, the number of statistical subintervals is at a minimum and is denoted as Pₘᵢₙ; therefore, the range for the suggested number of statistical subintervals is given as P∈[Pₘᵢₙ,Pₘₐₓ];
(7) the statistical interval [max (dist)−min(dist)] is divided into P subintervals with equal length; the number of samples in each subinterval is counted and denoted as pᵢ, i=(1, 2, . . . , P); the approximate probability in each subinterval is calculated using Pr(i)=pᵢ/P; the approximate probability curve is obtained through the weighted average procedure:
\hat{P}r(i)= 1/16(P(i−2)+4P(i−1)+6/P(i)+4P(i+1)+P(i+2))
where \hat{P}r is the approximate probability curve;
(8) local maximum values of \hat{P}r are picked out and the number of active modes is equal to the number of local maximum values.
